(19) United States
(12) Patent Application Publication
(10) Pub. No.: US 2004/0010555 A1
(43) Pub. Date: Jan. 15, 2004

(54) System for regulating electronics mail exchange flow and access to internet

(76) Inventor: Dany Cauchie, Perros Guirec (FR)

Correspondence Address: MCCRACKEN AND FRANK, 200 W. ADAMS STREET, SUITE 2150, CHICAGO, IL, 60606, US

(21) Appl. No.: 10/343,395

(22) PCT Filed: Aug. 1, 2001
(86) PCT No.: PCT/FR01/02513

(30) Foreign Application Priority Data
Aug. 3, 2000 (FR) 00/10258

(51) Int. Cl. G06F 15/16

(52) U.S. Cl. 709/206

(57) ABSTRACT

The invention concerns a system for regulating electronic mail exchange flow and access to network sites. Said system comprises at least, implanted at the access servers, a module controlling message reception by an addressee, enabling, when messages are received, to trigger a specific action regulating message reception, in accordance with the origin of the messages, and a module controlling message transmission by a transmitter enabling, when messages are sent, to trigger a specific action regulating transmission, in accordance with selection criteria of the addressees. The invention is applicable to electronic mail messages and/or access in access response to Internet or Intranet network sites.

The advent of new technologies, in particular of networked communication, has brought to the fore, or even magnified, the qualities or the defects of human behavior. Such a state of affairs is due, in particular, to the flexibility and to the growing ease of use of networked information and communication systems.

Among the aforesaid qualities may be mentioned the propensity of certain users to expound, on INTERNET sites for example, either with regard to their personal experience in relation to skill in situations of everyday life, as appropriate para-professional life, or in relation to how to live or else how to exist.

Such experiences usually allude to appraisals concerning products or services, to clever solutions to problems posed by substandard or imperfect widely disseminated products, such as in particular software marketed by unscrupulous or merely lax publishers, or various situations.

These appraisals usually turn out to be of benefit, not only with regard to actual or potential users, but also with regard to the providers of the products or services considered in these appraisals, as long as the latter exhibit a good level of objectivity, this usually being the case.

However, the behavior of the parties who demonstrate such qualities is rarely, if ever, rewarded, with the current lack of any system for recompensing them, at least indirectly.

On the contrary among the aforesaid defects may be mentioned the propensity of other users, often distinct from the former displaying these qualities, to abuse these networked information and communication systems.

One of these abuses, with growing prejudicial consequences, for certain users, of these networked information and communication systems, is the sending to the latter, by other users of a thoughtless number of electronic mail messages or of accesses to a networked site.

In particular it is common to address an electronic mail message not only to a specific recipient but also a copy of this electronic mail message to anybody mentioned as recipient by copy of any previous mail by this specific recipient. Thus, it is not rare for certain users to receive up to 200 or 300 electronic mail messages a day, this being liable, of course, to seriously hamper their efficiency of reply.

A comparable situation may be highlighted in relation to the sending of access messages, or of reply messages following access, to networked host sites, more commonly referred to as INTERNET sites. Specifically, neither access providers nor those in charge of sites hosting the aforesaid networked sites exercise any control whatsoever over the nature, the frequency or the content of the access messages or reply messages following access transmitted by their host sites.

Thus, in respect of mechanisms for transmitting electronic messages, the current techniques for managing electronic mail messages, also called personal messaging, whether these mechanisms be used within an individual context or on the scale of a business, do not offer solutions allowing effective control of each user's mailbox. Specifically, through the uncontrolled dissemination of electronic addresses, mailboxes are overloaded with electronic mail messages whose importance or relevance is not proven. Such an explosion in the number of electronic mail messages received is not directly controllable by the recipient who can do nothing but suffer such a situation.

Thoughtless use of electronic messaging systems is apparent in particular when each of the recipients of an electronic mailing sends a reply to all the recipients although this answer is of interest to the initial sender only. This results in blatant pollution of each of the mailboxes, especially in the case of a repeating loop, with no actual possibility of riposte.

Likewise, in respect of mechanisms for accessing networked sites, though certain server sites currently offer systems for enticing, or even for rewarding or for remunerating their users, such systems usually being translated into terms of coupons or loyalty points, these services remain the proprietors of their rewards. Stated otherwise, the rewards obtained by a user with regard to a service cannot generally be used other than within the context of this service. There is in fact no unifying service making it possible to manage all the rewards acquired by a user, this therefore preventing the latter from using them as he pleases. Thus, the mechanisms for rewarding, as appropriate for remunerating the users, are in no case concerned with electronic mail messages and their proper use. They are concerned only with remunerating or rewarding users for a job carried out on behalf of the service provider. By way of example, certain service providers remunerate users who put contributions onto their INTERNET sites. The reward, in terms of remuneration, is merely a compensation for the traffic generated by these contributions. Such a remuneration is therefore always dependent on what these contributions bring to the service provider himself. A user never receives any remuneration for his own job nor for his skill.

The object of the present invention is to remedy the drawbacks of the mechanisms for transmitting electronic messages, respectively of the mechanisms for accessing networked sites.

In particular, an object of the present invention is the implementation of an amalgamated unifying system making it possible at one and the same time to entice the regulating of the flows and the exchanges of electronic mail messages or of access messages, or of reply messages following access, to networked sites.

Another object of the present invention is the implementation of an amalgamated unifying system allowing, in addition to the regulating of the aforesaid flows and exchanges, enticement to the consultation of networked sites by a system for allocating rewards.

More specifically, in relation to the mechanism for exchanging electronic messages, another object of the present invention is to allow any user to regulate the influx of electronic mail messages into his mailbox and to regulate his sending of electronic mail messages by taking account in particular of the wishes and desires of his correspondents, following the receipt of previous electronic mail messages emanating from them.

In relation to the mechanism for exchanging access messages, or reply messages following access, of networked sites, another object of the present invention is to promote access to specific networked sites through the introduction of behavior parameters, such as loyalty, these behavior parameters not being tied however to the networked site in question but on the contrary managed by the network alone and hence usable over the whole of this network or over a substantial part thereof.

The system for regulating electronic mail message exchange flows and/or access to a networked site, which is the subject of the present invention, is noteworthy in that it comprises at least, installed at the level of the access servers, a module for controlling reception of messages, by a recipient, making it possible, during the reception of any message, to trigger a specific action of regulating reception of the messages, as a function of the origin of these messages and a module for controlling sending of messages, by a sender, making it possible, during the sending of any message destined for at least one recipient, to trigger a specific action of regulating sending of messages, as a function of criteria of choice of these recipients.

The system for regulating the flows of exchanges of electronic mail messages and/or of accesses to a networked site, which is the subject of the invention, will be better understood on reading the description and on looking at the drawings hereafter in which:

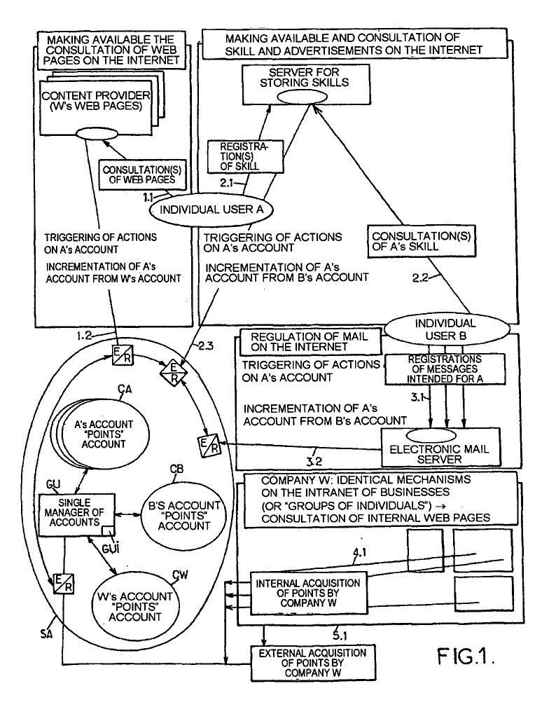

FIG. 1 represents, by way of nonlimiting example, the architecture of a system for regulating electronic mail exchange flows and access to a networked site, in accordance with the subject of the present invention;

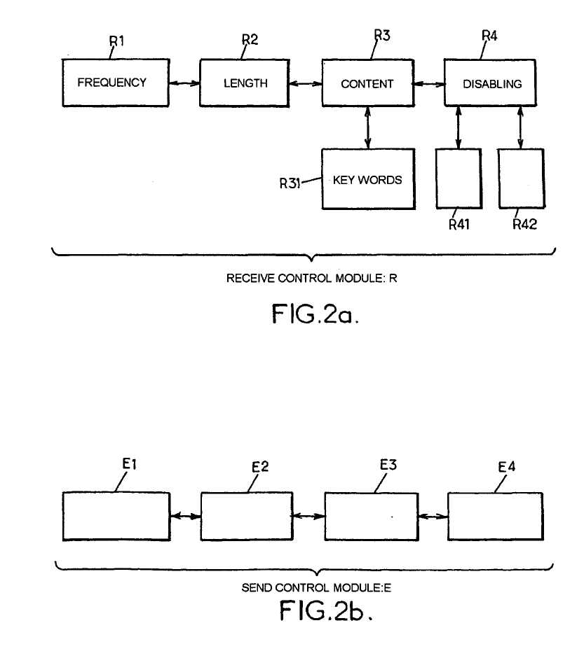

FIG. 2a represents, by way of illustration, a particular nonlimiting embodiment of a module for controlling reception of electronic messages, in accordance with the subject of the present invention;

FIG. 2b represents, by way of illustration, a particular nonlimiting embodiment of a module for controlling sending of electronic messages, in accordance with the subject of the present invention.

A more detailed description of a system for regulating electronic mail exchange flows and access to networked sites, in accordance with the subject of the present invention, will now be given in conjunction with FIG. 1.

Represented in the aforesaid FIG. 1 is a system for regulating electronic mail message exchange flows and/or access to a networked site in accordance with the subject of the present invention, this regulating system being intended to ensure the aforesaid regulating at the general level of a network, that is to say over a substantial part thereof.

The expression substantial part of the network is understood to mean for example any part of the network allowing the management of electronic addresses or of electronic sites exhibiting the same extension .com, .fr or the like.

For this reason, represented in FIG. 1 is an access server SA allowing any user, individual user A, individual user B or respectively group of users interconnected by a local network, a so-called INTRANET network, within the context of a commercial company, user W, itself interconnected to the access server SA.

Within the context of the elucidation of the system for regulating electronic mail message exchange flows and/or access to a networked site, which is the subject of the present invention, the users A, B respectively W, will be assigned distinct roles so as to allow a more detailed elucidation in the present description.

As mentioned previously, the individual user A is supposedly the recipient of a message within the context of the description of the system which is the subject of the present invention.

By way of nonlimiting example, it is indicated however that this individual user A has previously registered a skill or an aptitude on a server for storing skills by an operation bearing the reference 2.1 of registering skill, this skill being consultable for example by the individual user B.

The individual user A is also supposed to consult WEB pages on a networked site, such as any INTERNET site, by an operation of consulting WEB pages at a provider of content of the aforesaid WEB pages, which pages it will have been possible for the business or the commercial company W to provide. The operation of consulting the WEB pages bears the reference 1.1 for example.

In the same manner, the individual user B can send and register messages destined for the user A in an operation bearing the reference 3.1 at an electronic mail server.

As represented in FIG. 1, the system which is the subject of the present invention, comprises at least, installed at the level of each network-access server, and in particular at the access server represented and designated by SA, a module for controlling reception, denoted R, of messages by a recipient, this module for controlling reception making it possible, during the reception of any message, whether it be an electronic mail message and/or an access message or a message in reply to an access to a networked site, to trigger a specific action of regulating reception of these messages as a function of their origin.

Furthermore, as represented in FIG. 1, the system which is the subject of the present invention comprises at least one module for controlling sending of messages E by a sender, such as the user B for example, this or these modules E making it possible, during the sending of any message destined for at least one recipient, whether it be a recipient of an electronic mailing or a recipient of a message of access to a networked site, such as the user A, to trigger a specific action of regulating sending of messages as a function of criteria of choice of these recipients.

Represented in FIG. 1 by way of nonlimiting example is a plurality of modules for controlling reception of messages R and of modules for controlling sending of messages E. It is understood in particular that as a function of the architecture of the access server SA, the modules for controlling reception of messages R, respectively sending of messages E, can be grouped together into one and the same module, as appropriate into several modules, so as to ensure the processing of a plurality of messages transmitted to the access server SA.

Independently of the architecture, parallel or otherwise, of the modules for controlling reception of messages R, respectively of the modules for controlling sending of messages E, the latter are governed by a module GU, the user account single manager. An account of penalty points, respectively of bonus points, per user is also envisaged at the level of the access server SA per user, each account, for this reason, being referenced CA for the individual user A, CB for the individual user B, respectively CW for the commercial company user W.

As far as the architecture of the modules for controlling reception of messages R, respectively of the modules for controlling sending of messages E is concerned, it is indicated that each module can comprise a software part intended for detecting any message accessing the access server SA and intended for redirecting this message to the single manager of accounts GU, and a functional software part intended for carrying out all the functions of each module for controlling reception of messages R, respectively for controlling sending of messages E at the level of the single manager of accounts GU.

A more detailed description of a module for controlling reception R will now be given in conjunction with FIG. 2a.

With reference to the aforesaid figure, it is indicated that the module for controlling reception R advantageously comprises a module R₁ for controlling the frequency of the messages sent by each sender of messages, destined for a recipient.

The module for controlling reception of messages R also comprises a module R₂ for controlling the length of the messages sent by each sender of messages destined for a recipient, such as the recipient A. The control of the length of the messages is understood to mean either of the length of the main text of the latter, or of the number of attachments, or else of the overall volume of the message.

Furthermore, with reference to FIG. 2a, it is indicated that the module for reception of messages R comprises a module for controlling the content of the messages sent by each sender of messages destined for a recipient, the recipient A for example, this module bearing the reference R₃.

Furthermore, a database bearing the reference R₃₁ is linked directly to the module for controlling the content of messages R₃, this database R₃₁ comprising key words and being constructable on the initiative of the recipient, the recipient A for example. Specifically, the recipient A is able to construct one, or as appropriate, several databases as a function of the centers of interest of his activity and in particular of the messages which he is liable to receive from any sender. The key words can be subdivided into distinct databases relating either to professional activity, or to personal activity, and, within the context of this professional or personal activity, to various sectors thereof.

Finally, the module for controlling reception of messages R comprises, as represented in FIG. 2a, a module for disabling the reception of messages destined for a recipient, such as the recipient A, this module bearing the reference R₄.

By way of nonlimiting example, it is indicated that the module for disabling the reception of messages R₄ can be associated with a module for identifying the sender of the message, such as the user B in the aforesaid example, this identifying module bearing the reference R₄₁ and possibly consisting, by way of nonlimiting example, of a system for reading the electronic address of the sender B.

Furthermore, a module for evaluating a criterion of reluctance to read messages emanating from this sender B by the recipient A can also be associated with the module for disabling the reception of messages R₄. The module for evaluating criteria bears the reference R₄₂.

As far as the module for controlling sending of messages to a recipient is concerned, the module E as represented in FIG. 2b, this can comprise a module E₁ for calculating a coefficient of receptivity of the recipient to the messages dispatched by the sender, as well as a module E₂ for displaying a notification of receptivity of the recipient A destined for the sender, such as the user B.

The aforesaid modules E₁ and E₂ may be supplemented with a module E₃ for placing the sender B and the recipient A in telephonic communication as a function of the value of the coefficient of receptivity calculated by the module E₂.

Finally, the module for controlling sending of messages E can be furnished with a database E₄ relating to all the recipients who have received at least one message sent by the sender, the user B. The aforesaid database E₄ can be managed on the basis of criteria of reply of the various recipients.

Finally, the system with is the subject of the invention can comprise, at the level of the single manager module of user accounts GU, a module for enticing each sender or recipient to comply with a code of conduct relating to the sending/receiving of electronic messages, respectively of messages of access or of reply to access to a networked site. In FIG. 1, the module for enticement of each sender or recipient is referenced GUI and is supposedly, but not in a limiting manner, integrated into the single manager module of accounts GU.

Any other embodiment, in which the enticement module GUI is not integrated into the account single manager module GU, does not depart from the scope of the subject of the present invention.

In a general manner, it is indicated that the above cited code of proper conduct consists in defining, for each sender, respectively for each recipient, a plurality of threshold values of a set of behavioral variables pertaining to the number of messages sent or of messages of access, respectively of reply to access to networked sites, as a function of the identity of the recipient, respectively of the sender.

The enticement module GUI makes it possible to allocate bonus points to any sender or recipient for which at least one behavioral variable is less than a corresponding threshold value and in allocating penalty points to any sender or recipient, for which at least one behavioral variable is greater than this threshold value.

The general modus operandi of the system for regulating electronic mail exchange flows and access or reply to access to a networked site, which is the subject of the present invention, will now be described hereinafter. The system which is the subject of the present invention allows regulation in send mode or in receive mode within the context of electronic mail, as well as the integration of this regulation in relation to the other components of the INTERNET network and of the INTRANET network.

Within the context of the sending and the receiving of electronic mail messages, the system which is the subject of the invention makes it possible to entice the various parties, senders and receivers of electronic mail, to regulate their sending and receiving of mail. This concept is therefore based on a concept of triggering actions, during the sending or the receiving of the aforesaid mail.

Starting from the finding that a certain quota of mail received by an individual:

is not of interest to the latter at the precise moment at which he receives it;

is not of any interest to him at all;

does not concern him;

is not read owing to the very fact that the sender is known thereto,

the modules for controlling sending E, respectively receiving R installed at the level of the access server SA make it possible:

in respect of the receiver of a message, to trigger a specific action as a function of the actions undertaken by those who send messages thereto; this involves for example informing a sender, automatically, that he is perceived as too long-winded, too curious, and to penalize him therefor;

in respect of the sender of a message, to trigger a specific action as a function of the reactions of the recipients of this message and, for example, to select from among the aforesaid recipients those who are useful and those who are less so, depending on whether or not they have replied to previous mailings.

Thus, the system which is the subject of the invention enables each proprietor of a mailbox to determine:

In Receive Mode

that if a sender dispatches more than M messages to him during a given period P, and that the owner of the inbox, or mailbox, has not read any of them, then, there are grounds to trigger a particular action from among, for example, the actions hereinbelow:

specific identification of the sender by way of the module R₄₁ mentioned previously in conjunction with FIG. 2a,

outright rejection of the mail received or to be received during the period by way of the disabling module R₄ and the module R₄₂,

penalizing of the sender in question by way of the account unique manager module GU, as will be described subsequently in the description.

In Send Mode

that if he sends one or more messages to one and the same recipient and that the latter does not reply thereto, then, there are grounds to trigger a specific action, such as:

particular indication on the terminal of the sender, telephone terminal furnished with a display or personal computer;

attempted telephonic communication between the two users, sender and recipient;

recording of the characteristics of the recipient in a file or a database, file of those who never reply, file of those who are not interested, for later use.

As far as the integration of this regulation into the other components of the access to networked sites is concerned, the system which is the subject of the invention makes it possible, by virtue of the enticement of the various parties, sender and receiver of electronic mail in particular, to adopt an etiquette in respect of the proper usage of electronic mail and of accesses and replies to accesses to networked sites, the implementation of a methodology based on a reward and penalty concept reserved for each user, in particular individual.

The mechanism for regulating the message flows implemented by the system which is the subject of the present invention is thus based on a more general modus operandi enabling:

Individual users:

to acquire points by visiting the networked sites by way of the INTERNET and/or INTRANET network;

to acquire points by offering their skill to the other users of the INTERNET and/or INTRANET network through advertisements or through good ideas;

to acquire points by penalizing their electronic mail correspondents who are least respectful of the rules of etiquette thus instituted;

to cater for the management of their points account, points acquired globally by obtaining good points or deducting good points corresponding to penalties through a single intermediary, the access provider for example.

Commercial businesses:

to purchase points from this single intermediary;

to create points in house, by putting in place systems such as described previously, namely generation of points when the business accesses the INTRANET network or generation of points in conjunction with the proper use of internal electronic mail;

to distribute these points by allocating them to the individual users who visit their INTERNET site.

A specific exemplary operating procedure will now be given in conjunction with FIG. 1 within the context of the assumptions hereinbelow. The modus operandi is that which corresponds to the implementation of a single manager of accounts GU, which allows direct management of each user client account, user A, user B and user W, as mentioned previously in the description.

The first exemplary implementation corresponds to a making available and consultation of WEB pages on the INTERNET network.

This implementation is split into two steps, denoted 1.1 respectively 1.2 in which the individual user A consults the WEB pages of the commercial company W for example.

Following the consultation of the aforesaid WEB pages, an operation of triggering predefined actions on A's account is carried out by incrementing the points account CA of user A from W's user account. By the triggering of the predefined action on A's account, that is to say through the operation 1.2, the single manager of accounts GU updates W's and A's accounts by allotting a number of corresponding points in favor of A credited with the number of corresponding points in relation to W's account debited by the same number of corresponding points.

Another exemplary implementation relates to the making available and consultation of skill of advertisements on the INTERNET network.

This implementation is split into three steps denoted 2.1 of registering skill or aptitude by the individual user A on a server for storing skill, this operation being followed by an operation denoted 2.2 of consulting the skill registered by A at the level of the server for storing skill by the individual user B. Following this consultation operation, an operation of triggering a predefined action on A's account is carried out with the operation 2.3, this predefined action possibly corresponding for example to an action of incrementing A's user account from B's user account, this operation being carried out of course through the intermediary of the single manager of accounts GU updating A's and B's respective accounts.

The third exemplary implementation relates to electronic mail regulation, for example, which can be carried out by way of two actions, referenced 3.1 and 3.2 in FIG. 1.

In the course of the action 3.1, user B registers an electronic message intended for user A. The action 3.2 corresponds to a triggering of a predefined action on the user account CA of user A.

In the aforesaid exemplary embodiment, user A is represented solely as receiver of messages sent by user B. He may however be regarded here as sender of messages intended for user B for example. In such a case, the action referenced 3.2 could then correspond to a triggering of an action on behalf of user A because B, for example, has not replied to his messages.

The fourth exemplary implementation in FIG. 1 corresponds to the extrapolation of the previous three exemplary implementations, within the context this time of a commercial company or business by way of its INTRANET network. It is understood in particular that the mechanisms are substantially identical on the INTRANET network of the commercial businesses, or groups of individuals.

This fourth exemplary implementation is represented by two actions: an action referenced 4.1 corresponding to an internal acquisition of points by the company W, and an action referenced 5.1 corresponding to an external acquisition of points by the company W.

In the aforesaid four exemplary implementations, it is indicated that, on the one hand, the mechanisms implemented within a commercial business INTRANET network are the same as those implemented at the level of the INTERNET network, while, on the other hand, the aforesaid operations are unified by the single manager of accounts GU installed at the level of the access server SA.

In the aforesaid exemplary embodiments, the user A, individual user, thus has a points account, the account CA. The concept of points account encompasses that of advantages, reward, remuneration, which were mentioned previously in the description. For the user A, the actions triggered in all these situations are incrementations of user A's points account CA. Other actions may of course be envisaged and triggered, such as attempted telephonic communication, particular indication on the terminal of user A, management of black lists or of white lists for the aforesaid user A.

A summary of all the possibilities provided by the system for regulating electronic mail exchange flows and access to a networked site in accordance with the subject of the present invention is introduced hereinbelow in the description, by way of tables relating:

to the regulation of electronic mail in the guise of recipient, by way of the tables T1, T2 and T3;

to the regulation of electronic mail in the guise of sender, by way of the tables T4, T5;

to the making available and consultation of WEB pages on the INTERNET network, by way of the table T6;

to the making available and consultation of skill and of advertisements on the INTERNET network, by way of the table T7;

by way of identical mechanisms on the INTRANET network of the businesses or groups of individuals, by consultation of internal WEB pages, internal skill or of internal messaging, by way of the table T8.

The Regulation of Electronic Mail in the Guise of Recipient

A) Control of the Senders of Messages:

TABLE T1

| | | |
|---|---|---|
| | A has indicated to the | |
| | server SA that B is | |
| | “too long-winded”. | |
| | If B sends him M | |
| | messages at least | |
| | within a period of | |
| | P days, then A | |
| | requests that B be | |
| | warned, or even | |
| | “sanctioned” | |
| B sends a first | A does not read | |
| message to A | | |
| B sends a second | A does not read | |
| message to A | | |
| B sends a third | A does not read | The server SA |
| message to A | | detects |
| | | that A has |
| | | received M |
| | | successive |
| | | messages from B |
| | | (here M = 3) |
| | | and that A has |
| | | not read them. |
| | | Depending on what A |
| | | has requested: |
| | | the server SA |
| | | triggers this |
| | | action (for |
| | | example, |
| | | allocates points |
| | | to A's account, |
| | | which points are |
| | | removed from B's |
| | | account) |
| | | The server SA warns |
| | | B of the action |
| | | requested by A. |
| | | (For example, the |
| | | server SA warns B |
| | | that A finds him |
| | | “too long-winded” |
| | | and that points will |
| | | be debited from his |
| | | account in favor of |
| | | A). |

B) Control of the Senders of Messages and Rejection of Messages:

TABLE T2

| | | |
|---|---|---|
| | A has indicated to the | |
| | server SA that B is | |
| | “undesirable”. | |
| | Initially, if B sends | |
| | a message to A, A | |
| | requests that B be | |
| | warned that he is | |
| | undesirable. | |
| | Subsequently, if B | |
| | persists, A requests | |
| | that B be “sanctioned”. | |
| B sends a message | / | The server SA destroys |
| to A | | the message without |
| | | transmitting it to A. |
| | | The server SA warns B |
| | | that A finds him |
| | | “undesirable”. |
| B sends a message | / | The server SA |
| to A | | therefore allocates |
| | | points to A's account, |
| | | which points are |
| | | removed from B's |
| | | account. |

C) Control of the Senders of Messages and Identification:

TABLE T3

| | | |
|---|---|---|
| | A has indicated to the | |
| | server SA that B is | |
| | “not correct”. | |
| | If B sends him a message, | |
| | then A requests that this | |
| | message be clearly | |
| | identified as “not correct”. | |
| B sends a | | The server SA detects |
| message to A | | that for A, B is declared |
| | | “not correct”. |
| | | The server SA accompanies |
| | | B's message with an |
| | | indication signifying |
| | | “not correct”. |
| | | Depending on what A has |
| | | requested, the server SA |
| | | does or does not transmit |
| | | the message to A. |
| | | The server SA may |
| | | possibly carry out the |
| | | necessary points |
| | | transfers in cases A) or |
| | | B). depending on whether |
| | | B is designated as “too |
| | | long-winded” or |
| | | “undesirable”. |

The Regulation of Electronic Mail in the Guise of Sender

A) Control of the Recipients and Triggering of Action:

TABLE T4
1st case:

| | | |
|---|---|---|
| A has indicated to | | |
| the server SA that B | | |
| is known and | | |
| deserves particular | | |
| attention. | | |
| If A transmits N | | |
| messages to him and | | |
| if B does not reply | | |
| thereto, A requests | | |
| that a particular | | |
| action be triggered. | | |
| A sends a first | B does not reply | |
| message to B | thereto | |
| A sends a second | B does not reply | |
| message to B | thereto | |
| A sends a third | B does not reply | The server SA |
| message to B | thereto | detects: |
| | | that A has |
| | | transmitted N |
| | | message to B |
| | | (here N = 3) |
| | | that B has never |
| | | replied. |
| | | The server SA then |
| | | triggers the |
| | | particular action |
| | | requested by A, |
| | | for example: |
| | | attempted |
| | | telephonic |
| | | communication |
| | | between A and B, |
| | | recording of B's |
| | | particulars in a |
| | | file or a |
| | | database (for |
| | | example, a file |
| | | of the |
| | | “uninterested” |
| | | clients) |
| | | etc. |

TABLE T5
2nd case:

| | | |
|---|---|---|
| A has indicated to | | |
| the server SA that | | |
| his recipient or | | |
| recipients deserve | | |
| particular | | |
| attention. | | |
| If A transmits a | | |
| message to them, | | |
| then A requests that | | |
| a particular action | | |
| be triggered in | | |
| respect of all those | | |
| who have not replied | | |
| within a predefined | | |
| period. | | |
| A sends a message to | Some of these | The server SA then |
| one or more | recipients do not | triggers the |
| recipients. | reply thereto within | particular action |
| | the period. | requested by A, for |
| | | example: |
| | | retry by |
| | | resending the |
| | | message to those |
| | | who have not |
| | | replied, |
| | | recording of the |
| | | particulars of |
| | | the recipients |
| | | who have not |
| | | replied in a file |
| | | or a database |
| | | (for example, a |
| | | file of poor |
| | | payers, a file or |
| | | “uninterested” |
| | | clients). |

Making Available and Consultation of WEB Pages on the INTERNET Network

TABLE T6

| | | |
|---|---|---|
| | The business W has | |
| | acquired points from | |
| | the single manager | |
| | of accounts GU | |
| | The business W has | |
| | indicated to the content | |
| | provider who manages its | |
| | WEB pages that each | |
| | consultation of its WEB | |
| | site by a surfer brings | |
| | this surfer points. | |
| A consults the WEB | | The content provider |
| site of company W | | detects that A has |
| | | consulted the WEB |
| | | pages of the company |
| | | W. The content |
| | | provider therefore |
| | | allocates points to |
| | | A's account, which |
| | | points are removed |
| | | from the account of |
| | | business W. |

Making Available and Consultation of Skill and Advertisements on the INTERNET Network

TABLE T7

| | | |
|---|---|---|
| A registers a | | |
| contribution on a | | |
| skill server. | | |
| It indicates therein: | | |
| that it has | | |
| particular skills | | |
| and knowledge | | |
| regarding a | | |
| specific field, | | |
| that this skill is | | |
| worth X points. | | |
| | B consults A's skill | |
| | | The skill server |
| | | detects that B has |
| | | consulted A's |
| | | knowledge. |
| | | X points are therefore |
| | | allocated to A's |
| | | account, these points |
| | | being removed from B's |
| | | account. |

Identical Mechanisms on the INTRANET Network of Businesses (or Groups of Individuals)→Consultation of Internal WEB Pages, Internal Skill, Internal Messaging

TABLE T8

| | | |
|---|---|---|
| | The business W has | |
| | put in place on its | |
| | INTRANET network | |
| | principles identical | |
| | to those described | |
| | in T1, T2, T3, T4, | |
| | T5, T6, T7. | |
| An employee A | | The business W |
| consults the skill | | considers that it |
| of an employee B. | | will be able to |
| | | disburse X points in |
| | | favor of the surfers |
| | | who visit its WEB |
| | | site. |
| An employee C | | The business W |
| consults the WEB | | considers that it |
| pages of the | | will be able to |
| business W. | | disburse Y points in |
| | | favor of the surfers |
| | | who visit its WEB |
| | | site. |
| An employee D | | The business W |
| complies with the | | considers that it |
| rules of internal | | will be able to |
| messaging (for | | disburse Z points in |
| example, not more | | favor of the surfers |
| than 5 recipients, | | who visit its WEB |
| no message without | | site. |
| reply, etc.) | | |
| | The business W | |
| | therefore acquires | |
| | X + Y + Z points | |
| | from the single | |
| | manager of accounts | |
| | GU. | |
| | These points are | |
| | then distributable, | |
| | through the | |
| | intermediary of the | |
| | single manager of | |
| | accounts, to surfers | |
| | who visit the | |
| | external WEB site | |
| | of the company W. | |
| | (See table T6). | |

1. (Amended). A system for regulating electronic mail message exchange flows and/or access to a networked site, comprising at least, installed at the level of the access servers:
means of control of reception of messages, by a recipient, making it possible, during the reception of any message, to trigger a specific action of regulating reception of the messages, as a function of the origin of these messages; and
means of control of sending of messages, by a sender, making it possible, during the sending of any message destined for at least one recipient, to trigger a specific action of regulating sending of messages, as a function of criteria of choice of these recipients.

2. (Amended). The system as claimed in claim 1, wherein said means of control of reception of messages comprise means of control of the frequency of the messages sent by each message sender destined for a recipient.

3. (Amended). The system as claimed in claim 1 wherein said means of control of reception of messages comprise means of control of the length of the messages sent by each message sender destined for a recipient.

4. (Amended). The system as claimed in claim 1 wherein said means of control of reception of messages comprise means of control of the content of the messages sent by each message sender destined for a recipient, by comparing the content of each message with a set of key words stored in a database.

5. (Amended). The system as claimed in claim 1 wherein said means of control of reception of messages furthermore comprise means of disabling of the reception of messages destined for a recipient, upon a criterion of identification of the sender of this message and evaluation of a criterion of reluctance to read messages emanating from this sender by the recipient.

6. (Amended). The system as claimed in claim 1 wherein said means of control of sending of messages to a recipient comprise at least means of calculation of a coefficient of receptivity of said recipient to the messages dispatched by the sender.

7. (Amended). The system as claimed in claim 6, furthermore comprising means of display of a notification of receptivity of the recipient destined for this sender.

8. (Amended). The system as claimed in claim 6 comprising means for placing the sender and the recipient in telephonic communication, as a function of the value of said coefficient of receptivity.

9. (Amended). The system as claimed in claim 1 wherein said means of control of sending of messages to a recipient furthermore comprise a database relating to the entire set of recipients who have received at least one message sent by the sender, said database being managed on the basis of criteria of reply of said recipients.

10. (Amended). The system as claimed in claim 1 comprising means of enticement of each sender or recipient to comply with a code of conduct relating to the sending/receiving of electronic messages, respectively of access to a networked site, the code of proper conduct consisting in defining, for each sender respectively recipient, a plurality of threshold values of a set of behavioral variables pertaining to the number of messages sent or of accesses, respectively of messages received or of access returns, as a function of the identity of the recipient respectively of the sender, said means of enticement consisting in allocating bonus points to any sender, respectively recipient, for which at least one behavioral variable is less than a corresponding threshold value and in allocating penalty points to any sender, respectively recipient, for which at least one behavioral variable is greater than this threshold value.

11. (Amended). The system as claimed in claim 10, wherein said means of enticement comprise:
a single manager module for user accounts;
an account of penalty respectively bonus points per user, each account being managed by said single manager of accounts.
